(19) United States
(12) Patent Application Publication
(10) Pub. No.: US 2018/0327282 A1
(43) Pub. Date: Nov. 15, 2018

(54) WATER TREATMENT DEVICE AND HEATING COOKER PROVIDED WITH SAID WATER TREATMENT DEVICE

(71) Applicant: Panasonic Intellectual Property Management Co., Ltd., Osaka (JP)

(72) Inventors: MASAKI SHIBUYA, Osaka (JP); AKIRA KATAOKA, Shiga (JP)

(21) Appl. No.: 15/775,869

(22) PCT Filed: Oct. 19, 2016
(86) PCT No.: PCT/JP2016/004618

§ 371 Date: May 14, 2018

(30) Foreign Application Priority Data
Dec. 16, 2015 (JP) 2015-244777

(51) Int. Cl. C02F 1/42; F24C 15/32

(52) U.S. Cl. CPC C02F 1/42; C02F 2101/10; F24C 15/327

(57) ABSTRACT

Provided is water treatment container in which water treatment material for treating water passing through at least a part of water treatment material is sealed. Water treatment container has water treatment container inlet port, which is an inlet port, and water supply pump connection-part, which is an outlet port, on horizontally opposite ends of water treatment container. Space defined between a surface of an upper inner wall of water treatment container and water treatment material is provided on at least a part of water treatment container from water treatment container inlet port to water supply pump connection-part. According to this configuration, if dust component is accumulated in water treatment material because of water treatment, water flows in space defined between the surface of the upper inner wall of water treatment container and water treatment material, which functions as a bypass. It is thus possible to prevent an increase in a pressure loss and a reduction in a flow rate without degrading water treatment performance.

### TECHNICAL FIELD

The present invention relates to a water treatment device and a heating cooker provided with the water treatment device.

### BACKGROUND ART

In this type of a water treatment device and a heating cooker provided with the water treatment device, a suction tube is conventionally provided such that a length of the suction tube is vertical. A water treatment material is filled in the suction tube from an inlet port to an outlet port without any gap between the water treatment material and an inner wall of the suction tube (for example, see PTL 1).

### CITATION LIST

### Patent Literature

PTL 1: Unexamined Japanese Patent Publication No. H10-110903

### SUMMARY OF THE INVENTION

However, while water treatment is performed, a dust component such as fine sand in water is accumulated in a water treatment material, and thus a pressure loss is increased and a flow rate is reduced.

An object of the present invention is to provide a water treatment device that prevents an increase in a pressure loss and a reduction in a flow rate because of accumulation of a dust component such as fine sand in water in a water treatment material during water treatment, and a heating cooker provided with the water treatment device.

A water treatment device and a heating cooker provided with the water treatment device according to the present invention include a water treatment container in which a water treatment material for treating water passing through at least a part of the water treatment material is sealed, the water treatment container having an inlet port and an outlet port on horizontally opposite ends of the water treatment container, wherein a space defined between a surface of an upper inner wall of the water treatment container and the water treatment material is provided on at least a part of the water treatment container from the inlet port to the outlet port.

According to this configuration, when water treatment is performed and thus a dust component such as fine sand in water is accumulated in the water treatment material, the water treatment material in which the dust component is gradually accumulated has a large pressure loss. Most of the water flows in the space defined between the surface of the upper inner wall of the water treatment container and the water treatment material, which functions as a bypass flow passage. The water passes through the space on the water treatment material in which the dust component is gradually accumulated, and then flows downward in the water treatment material by gravity. It is thus possible to prevent an increase in the pressure loss and a reduction in the flow rate without degrading water treatment performance.

### BRIEF DESCRIPTION OF DRAWINGS

FIG. 1 is a perspective view of a water treatment device according to a first exemplary embodiment of the present invention.

FIG. 2 is a plane cross-sectional view showing a state where a lid of a water supply tank is removed in the water treatment device according to the first exemplary embodiment of the present invention.

FIG. 3 is a front cross-sectional view of the water treatment device according to the first exemplary embodiment of the present invention.

FIG. 4 is a side cross-sectional view showing a state where a water treatment container is attached to the water treatment device according to the first exemplary embodiment of the present invention.

FIG. 5A is a side cross-sectional view showing a state where the water treatment container is connected to the water supply tank in the water treatment device according to the first exemplary embodiment of the present invention.

FIG. 5B is a side cross-sectional view showing a state where the water treatment container is taken out of the water supply tank in the water treatment device according to the first exemplary embodiment of the present invention.

FIG. 6A is a side cross-sectional view showing a state where the water treatment container is connected to a water supply pump in the water treatment device according to the first exemplary embodiment of the present invention.

FIG. 6B is a side cross-sectional view showing a state where the water treatment container is taken out of the water supply pump in the water treatment device according to the first exemplary embodiment of the present invention.

FIG. 7A is a side cross-sectional view of proximity of the water treatment container, showing a water flow before a dust component is accumulated, in the water treatment device according to the first exemplary embodiment of the present invention.

FIG. 7B is a side cross-sectional view of the proximity of the water treatment container, showing a water flow when a dust component is accumulated during water treatment, in the water treatment device according to the first exemplary embodiment of the present invention.

FIG. 8 is a side cross-sectional view of proximity of a water treatment container in a water treatment device according to a second exemplary embodiment of the present invention.

FIG. 9 is a side cross-sectional view of the proximity of the water treatment container, showing a water flow when a dust component is accumulated and a flow rate of a water supply pump is large, in the water treatment device according to the second exemplary embodiment of the present invention.

FIG. 10 is a perspective view of a heating cooker provided with a water treatment device according to a third exemplary embodiment of the present invention.

FIG. 11 is a front cross-sectional view of the heating cooker provided with the water treatment device according to the third exemplary embodiment of the present invention.

FIG. 12 is a side cross-sectional view of the heating cooker provided with the water treatment device according to the third exemplary embodiment of the present invention.

FIG. 13 is a top view of a tank case, a water supply tank from which a lid is removed, and a drain water tank in the heating cooker provided with the water treatment device according to the third exemplary embodiment of the present invention.

### DESCRIPTION OF EMBODIMENTS

Hereinafter, exemplary embodiments of the present invention will be described with reference to the drawings. The present invention is not limited to the exemplary embodiments.

### First Exemplary Embodiment

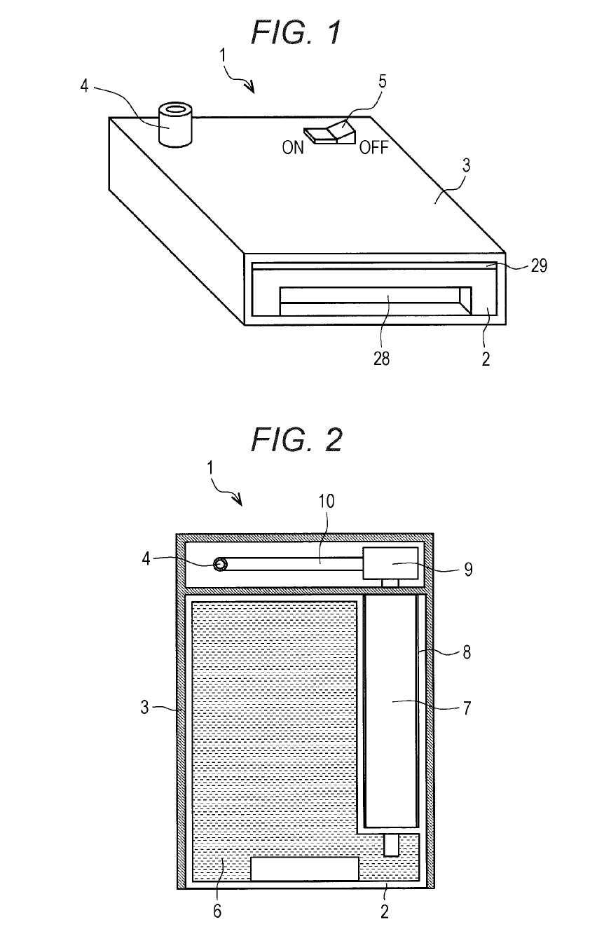

FIG. 1 is a perspective view of a water treatment device according to a first exemplary embodiment of the present invention.

In FIG. 1, water treatment device 1 includes water supply tank 2 that stores water, tank case 3 that has an opening and accommodates water supply tank 2, discharge port 4 that externally discharges treated water, which is obtained by treating water in water supply tank 2, and switch 5 that switches ON and OFF an operation of water treatment device 1.

Water supply tank lid 29 with a water filler (not shown) is provided on an upper part of water supply tank 2. Water supply tank 2 and water supply tank lid 29 are formed of a transparent resin so that an amount of water stored can be easily checked. Water supply tank 2 has recess 28 for receiving a finger so as to be easily taken out of tank case 3.

While discharge port 4 is provided on an upper portion of tank case 3 in the present exemplary embodiment, discharge port 4 may be provided on a lower portion or a side surface of tank case 3. While water treatment device 1 has switch 5 that switches ON and OFF the operation of water treatment device 1, water treatment device 1 may include an operation unit that can specifically set a flow rate or may be connected to other devices to be operated by the other devices.

FIG. 2 is a plane cross-sectional view showing a state where a lid of a water supply tank is removed in the water treatment device according to the present exemplary embodiment.

In FIG. 2, water supply tank 2 is constituted by water storage chamber 6 that stores water and water treatment container accommodating part 8 that detachably accommodates water treatment container 7 on a right side of water storage chamber 6 and outside water storage chamber 6. Water supply pump 9 is provided on a rear of water treatment container 7 (an upper side in FIG. 2). Water supply pump 9 supplies water in water supply tank 2 through water supply passage 10 formed of a silicon tube to discharge port 4. Water treatment container 7 may be accommodated in a center of water supply tank 2 or on a left side of water supply tank 2.

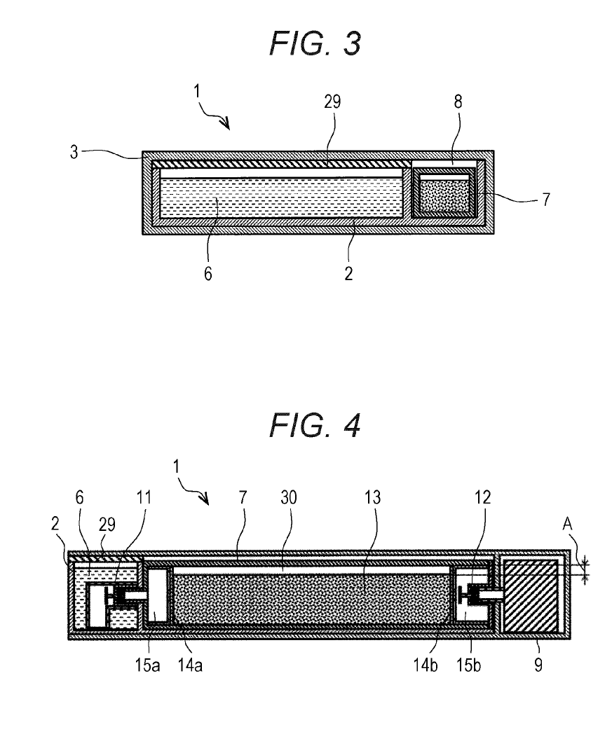

FIG. 3 is a front cross-sectional view of the water treatment device according to the present exemplary embodiment.

In FIG. 3, water treatment container accommodating part 8 that accommodates water treatment container 7 has an opening at its upper part and a U-shaped cross-section. After water supply tank 2 is taken out of tank case 3, while a connection state of water treatment container 7 is visually checked from above water supply tank 2, water treatment container 7 is accommodated in water treatment container accommodating part 8 and then slid to be easily connected to water supply tank 2.

While water treatment container 7 is formed in a substantially rectangular parallelepiped shape, water treatment container 7 may be formed in a cylindrical shape or the like.

FIG. 4 is a side cross-sectional view of proximity of a water treatment container in the water treatment device according to the present exemplary embodiment.

In FIG. 4, water supply tank 2 includes water treatment container connection-part 11 fixed to water supply tank 2. Water supply tank 2 is easily detachable from water treatment container 7 via water treatment container connection-part 11, and is connected to water treatment container 7 to communicate with water treatment container 7. Water treatment container 7 is disposed such that a length is substantially horizontal, and has water supply pump connection-part 12 fixed to water treatment container 7. Water treatment container 7 is easily detachable from water supply pump 9 via water supply pump connection-part 12, and is connected to water supply pump 9 to communicate with water supply pump 9.

Water treatment material 13 that is sandwiched between mesh members 14a, 14b obtained by integrally molding a resin mesh with a resin is accommodated in water treatment container 7. In water treatment container 7, water can pass through from water treatment container connection-part 11 to water supply pump connection-part 12.

Space 30 is formed by a surface of an upper inner wall of water treatment container 7, water treatment material 13, and mesh members 14a, 14b. Space 30 has height dimension A.

Water treatment material 13 is made of a particulate ion exchange resin that converts cations such as calcium ions in the water into hydrogen ions and anions such as silica ions into hydroxide ions to purify the water. The water treated by water treatment material 13 is used for drinking, or is supplied to a steam generating device to prevent scale components such as calcium and silica from being deposited and adhered to the steam generating device.

While the ion exchange resin that purifies water is used as water treatment material 13 in the present exemplary embodiment, any material that removes predetermined components in the water according to applications, including an ion exchange resin that removes only cations in the water and substitutes the cations for sodium ions to soften the water, may be used.

An opening of the resin mesh constituting mesh members 14a, 14b has a diameter of approximately 0.15 mm. This diameter is set to be smaller than a particle diameter of water treatment material 13 of approximately 0.3 mm, for the purpose of preventing particles of water treatment material 13 from passing through the openings.

A particle size of water treatment material 13 varies depending on materials, and the opening of the resin mesh is appropriately selected accordingly.

Diffusion spaces 15a, 15b are respectively defined by mesh members 14a, 14b on both sides of water treatment material 13 in water treatment container 7, for the purpose of enabling entering or exiting water to pass through overall water treatment material 13 and extending a lifetime of water treatment material 13.

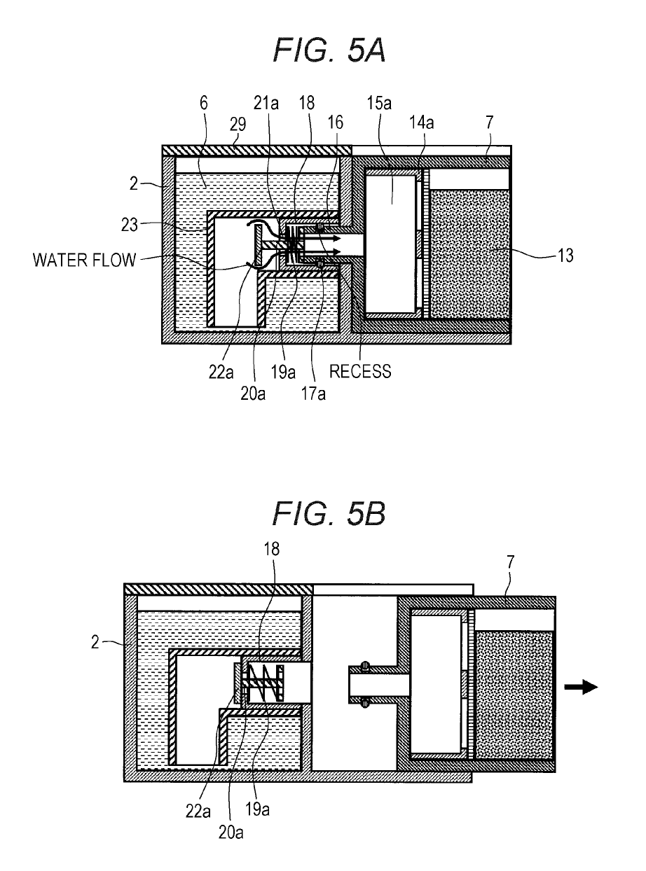

FIG. 5A is a side cross-sectional view showing a state where the water treatment container of the water treatment device is connected to the water supply tank, according to the present exemplary embodiment. FIG. 5B is a side cross-sectional view showing a state where the water treatment container is taken out of the water supply tank in the water treatment device according to the present exemplary embodiment.

In FIG. 5A, water treatment container inlet port 16, which is an inlet port, formed in a cylindrical shape is provided on a front of water treatment container 7 (a left side in FIGS. 5A and 5B), and O-ring 17a is provided in a recess of water treatment container inlet port 16. O-ring 17a press-contacts an inner wall of water treatment container connection-part 18 of water supply tank 2 to prevent water leakage.

Valve spring 19a, valve shaft 20a that is always pressed rearward (a right side in FIGS. 5A and 5B) by valve spring 19a, and valve 22a formed of a silicone rubber are included in water treatment container connection-part 18. Valve 22a has valve shaft 20a passing through valve shaft hole 21a, and is formed on the front of valve shaft 20a.

In FIG. 5A, valve shaft 20a is pressed forward by water treatment container inlet port 16, which is an inlet port, and thus valve spring 19a is compressed to open valve 22a, so that water supply tank 2 communicates with water treatment container 7.

An end of water supply pipe 23 with an elbow cross-section in a length is attached to outside of water treatment container connection-part 18 by a press-fit, for the purpose of sucking up the water at a bottom of water storage chamber 6.

In FIG. 5B, when water treatment container 7 is taken out of water supply tank 2, valve shaft 20a is pressed rearward by valve spring 19a and thus valve 22a press-contacts water treatment container connection-part 18 to be closed, so that water leakage from water supply tank 2 is prevented.

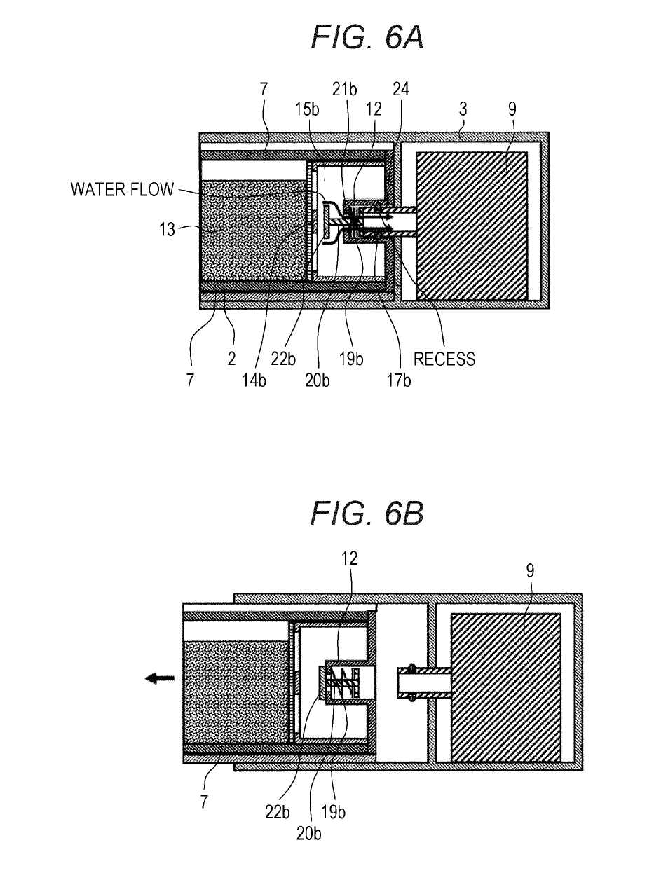

FIG. 6A is a side cross-sectional view showing a state where water treatment container 7 is connected to water supply pump 9, according to the present exemplary embodiment. FIG. 6B is a side-cross sectional view showing a state where water treatment container 7 is taken out of water supply pump 9, according to the present exemplary embodiment.

In FIG. 6A, water supply pump inlet port 24 formed in a cylindrical shape is provided on the front of water supply pump 9 (a left side in FIG. 6A), and O-ring 17b is provided in a recess of water supply pump inlet port 24. O-ring 17b press-contacts an inner wall of water supply pump connection-part 12, which is an outlet port of water treatment container 7, to prevent water leakage.

Valve spring 19b, valve shaft 20b that is always pressed rearward (a right side in FIG. 6B) by valve spring 19b, and valve 22b formed of a silicone rubber are included in water supply pump connection-part 12, which is an outlet port. Valve 22b has valve shaft 20b passing through valve shaft hole 21b, and is formed on the front of valve shaft 20b.

In FIG. 6A, valve shaft 20b is pressed forward by water supply pump inlet port 24 and thus valve spring 19b is compressed to open valve 22b, so that water supply pump 9 communicates with water treatment container 7.

In FIG. 6B, when water treatment container 7 is taken out of water supply pump 9, valve shaft 20b is pressed rearward by valve spring 19b and thus valve 22b press-contacts water supply pump connection-part 12 to be closed, so that water leakage from water treatment container 7 is prevented.

The operation and effect of the water treatment device having the above-mentioned configuration are hereinafter described.

A user of water treatment device 1 first pulls out water supply tank 2 from tank case 3, pours water from a water filler (not shown) into water storage chamber 6 in water supply tank 2, and inserts water supply tank 2 fully into tank case 3.

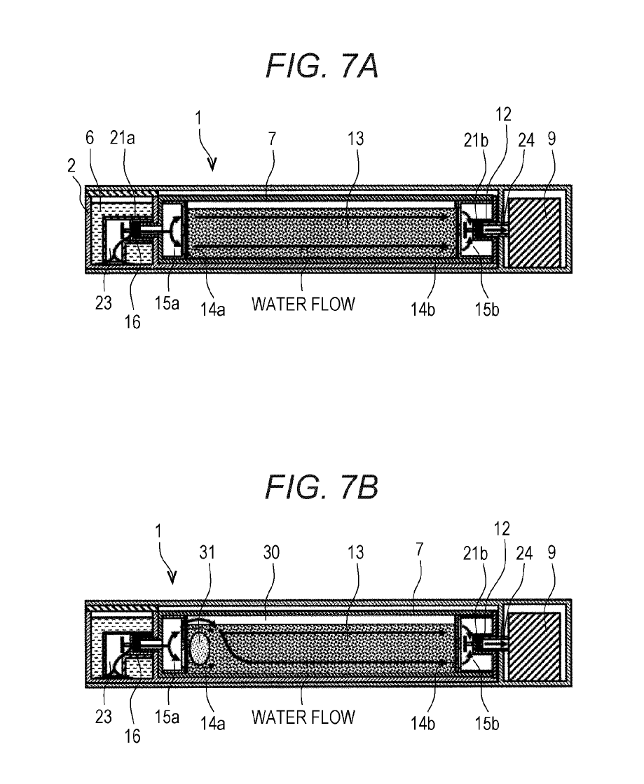

FIG. 7A is a side cross-sectional view of proximity of the water treatment container, showing a water flow before a dust component is accumulated, in the water treatment device according to the present exemplary embodiment. FIG. 7B is a side cross-sectional view of the proximity of the water treatment container, showing a water flow when a dust component is accumulated during water treatment, in the water treatment device according to the present exemplary embodiment.

As shown in FIG. 7A, when switch 5 is turned ON, water supply pump 9 causes water in water storage chamber 6 to flow through water supply pipe 23, valve shaft hole 21a, water treatment container inlet port 16, which is an inlet port, diffusion space 15a, mesh member 14a, and water treatment material 13, so that water treatment is performed on the water. The water having treated by water treatment material 13 flows through mesh member 14b, diffusion space 15b, valve shaft hole 21b formed in water supply pump connection-part 12, which is an outlet port, and water supply pump inlet port 24.

As shown in FIG. 7B, as the water treatment is continuously performed, dust component 31 such as fine sand having passed through mesh member 14a is accumulated in water treatment material 13 near mesh member 14a.

When switch 5 is turned ON under such a state, water supply pump 9 causes water in water storage chamber 6 to flow through water supply pipe 23, valve shaft hole 21a, water treatment container inlet port 16, and diffusion space 15a. As water treatment material 13 near mesh member 14a has a large pressure loss because of dust component 31, the water avoids dust component 31 and passes through space 30 on an upper surface of water treatment material 13 in which dust component 31 is gradually accumulated.

When the water reaches the upper surface of water treatment material 13 where dust component 31 is not accumulated, the water flows downward in water treatment material 13 by gravity. Thereafter, as in a case before dust component 31 is accumulated, the water flows through mesh member 14b, diffusion space 15b, valve shaft hole 21b formed in water supply pump connection-part 12, which is an outlet port, and water supply pump inlet port 24.

As described above, space 30 opposing the upper surface of water treatment material 13 is used for enabling water to flow while avoiding dust component 31 when dust component 31 is accumulated in water treatment material 13. It is thus sufficient that height dimension A of space 30 is approximately 1 mm. Height dimension A of space 30 does not need to be equal over an entire area in the length. Effects can be achieved even if height dimension A is not equal over the entire area in the length. This is because water treatment material 13 is particulate and a height dimension of water treatment material 13 is equalized by itself by gravity.

While the water passes through water treatment material 13, cations such as calcium ions in the water are converted into hydrogen ions and anions such as silica ions are converted into hydroxide ions. The water flown out of water supply pump 9 then passes through water supply passage 10 to be externally discharged from discharge port 4.

When water treatment container 7 is replaced, water supply tank 2 is first taken out of tank case 3. At this time, water treatment container 7 that is connected to the outside of water supply tank 2 is also taken out with water supply tank 2. Next, water treatment container 7 is slid to be taken out of water supply tank 2. In this state, water treatment container 7 is not immersed in water storage chamber 6 in water supply tank 2. In addition, valves 22a, 22b are closed and thus when water treatment container 7 is taken out, water hardly drips from water treatment container 7 and water supply tank 2. As a result, it is possible to easily replace water treatment container 7.

As described above, in the present exemplary embodiment, there is provided water treatment container 7 in which water treatment material 13 for treating water passing through at least a part of water treatment material 13 is sealed. Water treatment container 7 has water treatment container inlet port 16, which is an inlet port, on one end side in the horizontal direction and water supply pump connection-part 12, which is an outlet port, on another end side in the horizontal direction. In addition, space 30 defined between the surface of the upper inner wall of water treatment container 7 and water treatment material 13 is formed on at least a part of water treatment material 13 from water treatment container inlet port 16 to water supply pump connection-part 12. According to this configuration, when the water treatment is performed and thus dust component 31 such as fine sand in water is accumulated in water treatment material 13, water treatment material 13 in which dust component 31 is accumulated has a large pressure loss. Most of the water flows in space 30 defined between the surface of the upper inner wall of water treatment container 7 and water treatment material 13, which functions as a bypass flow passage.

The water passes through space 30 on water treatment material 13 in which dust component 31 is gradually accumulated, and then flows downward in water treatment material 13 by gravity. It is thus possible to prevent an increase in the pressure loss and a reduction in the flow rate without degrading water treatment performance.

In addition, the length of water treatment container 7 is substantially horizontal. Water treatment material 13 thus remains in a lower portion of water treatment container 7 by gravity. As a result, it is possible to form space 30 by itself between the surface of the upper inner wall of water treatment container 7 and water treatment material 13 without using other members. Moreover, it is possible to substantially equalize height dimension A of space 30 over the entire area in the length. Additionally, the length of water supply tank 2 is also substantially horizontal. It is thus possible to form tank case 3 in a flat shape and keep a low overall height of water treatment device 1, so that compact water treatment device 1 is achieved.

### Second Exemplary Embodiment

Next, a second exemplary embodiment of the present invention will be described. Differences from configurations and operations of the first exemplary embodiment are mainly described below. Same reference marks are given to same elements as those of the first exemplary embodiment, and detailed descriptions of configurations and operations of the same elements are omitted.

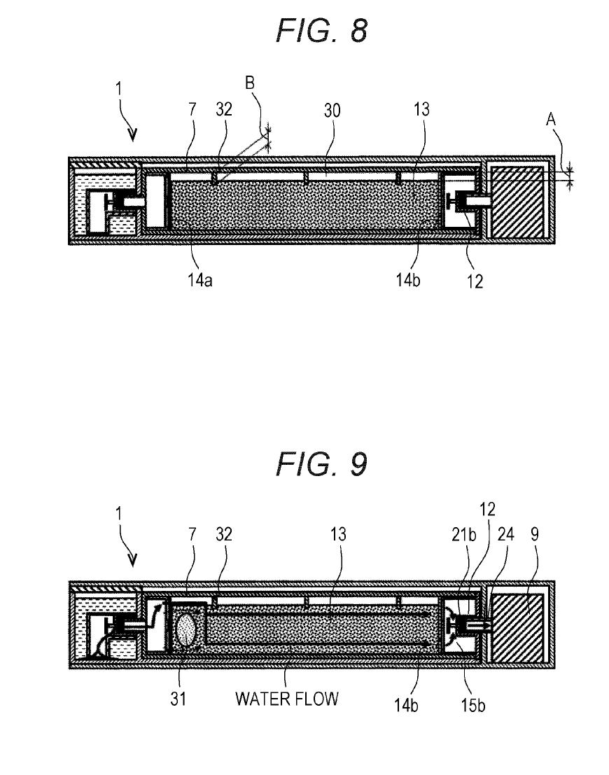

FIG. 8 is a side cross-sectional view of proximity of a water treatment container in a water treatment device according to the present exemplary embodiment.

Space 30 surrounded by a surface of an upper inner wall of water treatment container 7, water treatment material 13, and mesh members 14a, 14b has height dimension A. Space 30 is partitioned into four small spaces by three partition plates 32. Each of partition plates 32 has height dimension B from the surface of the upper inner wall of water treatment container 7, and is formed integrally with the surface of the upper inner wall of water treatment container 7. Height dimension B is set to be larger than height dimension A. A distal end of partition plate 32 is embedded in water treatment material 13.

The operation and effect of the water treatment device having the above-mentioned configuration are hereinafter described.

A user of water treatment device 1 first pulls out water supply tank 2 from tank case 3, pours water from a water filler (not shown) into water storage chamber 6 in water supply tank 2, and inserts water supply tank 2 fully into tank case 3.

FIG. 9 is a side cross-sectional view of the water treatment device according to the second exemplary embodiment of the present invention, showing a water flow when a dust component is accumulated and a flow rate of a water supply pump is large.

As shown in FIG. 9, water flowing in space 30 is guided by partition plates 32 into water treatment material 13. Consequently, as compared to a case where partition plates 32 are not provided, the water can flow in a lower portion of water treatment material 13, water treatment material 13 can be effectively used, and a lifetime of water treatment material 13 can be extended. Thereafter, as in the case before dust component is accumulated, the water flows through mesh member 14b, diffusion space 15b, valve shaft hole 21b formed in water supply pump connection-part 12, which is an outlet port, and water supply pump inlet port 24.

While the water passes through water treatment material 13, cations such as calcium ions in the water are converted into hydrogen ions and anions such as silica ions are converted into hydroxide ions. The water flown out of water supply pump 9 then passes through water supply passage 10 to be externally discharged from discharge port 4.

As described above, partition plates 32 that partition space 30 are formed in at least a part of space 30 in the present exemplary embodiment. Consequently, while water flows through space 30 formed between the surface of the upper inner wall of water treatment container 7 and water treatment material 13, the water can be guided into water treatment material 13. It is thus possible to prevent the water from flowing only in space 30 without passing through water treatment material 13 and the water treatment performance from being degraded. In addition, while water treatment device 1 is carried, water treatment material 13 is held by partition plates 32. It is thus possible to prevent water treatment material 13 from being moved in water treatment container 7 and gathered to one side.

While three partition plates 32 are provided in the present exemplary embodiment, a number of partition plates 32 may be increased or reduced depending on a flow rate and a pressure loss of water treatment material 13.

### Third Exemplary Embodiment

Next, a third exemplary embodiment of the present invention will be described. Differences from configurations and operations of the first exemplary embodiment are mainly described below. Same reference marks are given to same elements as those of the first exemplary embodiment, and detailed descriptions of configurations and operations of the same elements are omitted.

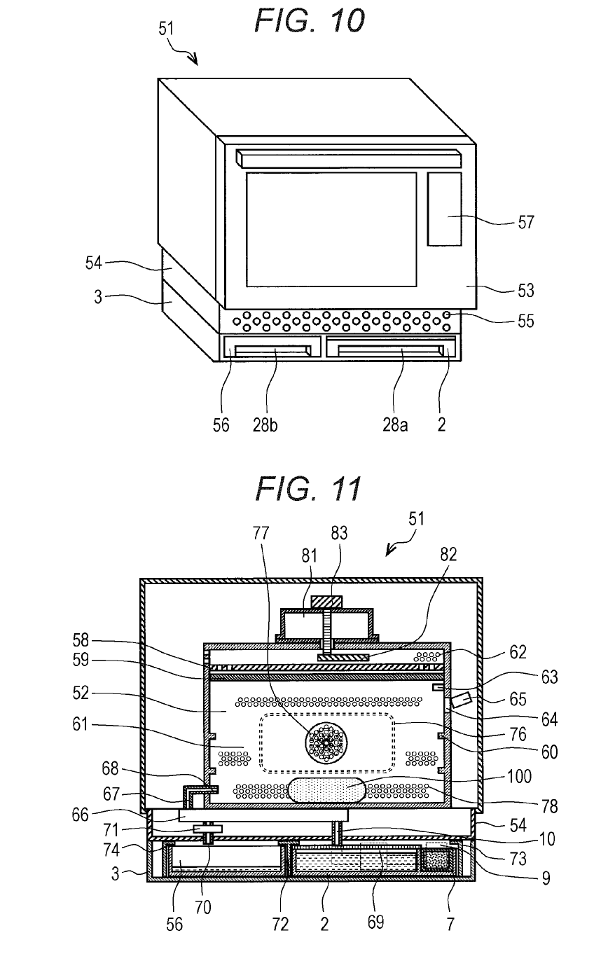

FIG. 10 is a perspective view of a heating cooker provided with a water treatment device according to the present exemplary embodiment.

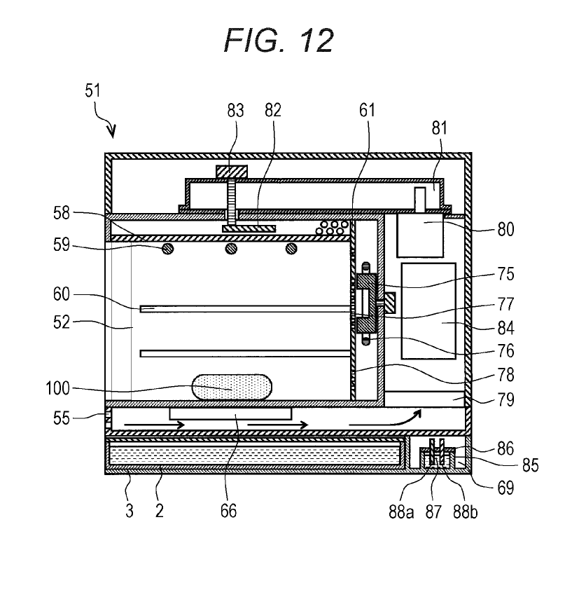

In FIG. 10, heating chamber 52 to be described later (see FIGS. 11 and 12) is provided in a main body of heating cooker 51. Heating chamber 52 has an opening on a front surface. Door 53, which is openable, is provided in the opening. A user of heating cooker 51 rotates door 53 toward oneself to open door 53, and puts a food in heating chamber 52 or takes the food out of heating chamber 52 through the opening.

Bottom plate 54 supporting heating chamber 52 is provided under heating cooker 51. Tank case 3 supporting bottom plate 54 is provided under bottom plate 54. Tank case 3 accommodates water supply tank 2 and drain water tank 56 to be easily detachable on a substantially whole side of tank case 3 where the opening of heating chamber 52 is formed.

Recesses 28a, 28b are formed in a front part of tank case 3 for a user to easily put or take water supply tank 2 and drain water tank 56 in or out of tank case 3 with a hand. Water supply tank 2 is formed of a transparent resin so that an amount of water stored can be easily checked. A plurality of cooling air inlet ports 55 for taking cooling air in heating cooker 51 are formed above water supply tank 2 and drain water tank 56 and on a side of bottom plate 54 where the opening of heating chamber 52 is formed.

In the present exemplary embodiment, a following description is made assuming that a side of the opening of heating chamber 52 is referred to as front, a right side when a user faces rear while standing at the front is referred to as right, and a left side when the user faces the main body while standing at the front is referred to as left.

Door 53 is formed to be vertically openable. Operation display unit 57 for a user to set a cooking menu and a cooking time is formed on a front surface of door 53. A safety switch (not shown) for stopping operations of heat sources in heating cooker 51 when door 53 is opened is provided in the main body of heating cooker 51.

FIG. 11 is a front cross-sectional view of the heating cooker provided with the water treatment device according to the present exemplary embodiment.

In FIG. 11, wall surfaces of heating chamber 52 are formed by coating a surface of an aluminum-plated steel plate with fluorine. Top plate 58 made of mica is provided on a top surface of heating chamber 52 and under top plate 58, three bar-shaped heating chamber heaters 59 are provided to be parallel to each other toward the rear.

The wall surfaces of heating chamber 52 are grounded by an earth cord (not shown). Rail 60 is integrally molded with each of left and right side walls of heating chamber 52 to easily detachably hold a tray (not shown). Consequently, rails 60 are also grounded.

While the wall surface of heating chamber 52 is coated with fluorine so that dirt can be easily wiped off in the present exemplary embodiment, the wall surface may be coated with enamel or other heat-resistant coating may be performed on the wall surface. Alternatively, stainless may be used as a material for the wall surface of heating chamber 52.

A plurality of heating chamber exhaust holes 62 for externally discharging air in heating chamber 52 are formed in an upper right part of partition wall 61, which is an innermost wall of heating chamber 52. Infrared sensor 65 and in-chamber thermistor 63 are provided on an upper part of the right wall of heating chamber 52. Infrared sensor 65 detects a temperature of a food in heating chamber 52 or a temperature of a food container in heating chamber 52 through detection hole 64 formed in the right wall of heating chamber 52. In-chamber thermistor 63 detects an in-chamber atmosphere temperature.

Steam generating device 66 that generates steam is provided under and outside heating chamber 52. Steam introduction passage 67 is connected to an upper part of steam generating device 66 to supply steam from a left side surface of heating chamber 52 into heating chamber 52. Steam ejection port 68, which is at a distal end of steam introduction passage 67, is fixed to the side wall of heating chamber 52 to eject steam horizontally into heating chamber 52.

Tank case 3, and water supply tank 2 and drain water tank 56 accommodated in tank case 3 are provided below steam generating device 66. Steam generating device 66 is connected via water supply pump 9 and electric conductivity measurement device 69 to water supply tank 2 by water supply passage 10.

One end of drain passage 70 that drains water from steam generating device 66 is connected to steam generating device 66. The other end of drain passage 70 passes through drain valve 71 to extend above drain water tank 56. Consequently, when drain valve 71 is opened, water in steam generating device 66 is drained into drain water tank 56. Drain valve 71 is normally closed and thus the water in steam generating device 66 is not drained. Steam introduction passage 67 and drain passage 70 are formed of a silicone tube.

While water supply tank 2 is disposed on the right and drain water tank 56 is disposed on the left in the present exemplary embodiment, water supply tank 2 may be disposed on the left and drain water tank 56 may be disposed on the right. Alternatively, water supply tank 2 and drain water tank 56 may be disposed in a front-rear direction.

Tank case 3 includes center part partition 72 formed between water supply tank 2 and drain water tank 56, water supply tank guide 73 that is formed on both sides of an upper part of water supply tank 2 and functions as a guide when water supply tank 2 is pulled out, and drain water tank guide 74 that is formed on both sides of an upper part of drain water tank 56 and functions as a guide when drain water tank 56 is pulled out. Bottom plate 54 can be supported by and fixed to tank case 3 from below using a left wall, a right wall, and a rear wall of tank case 3.

Food 100 is disposed on a bottom part of heating chamber 52.

FIG. 12 is a side cross-sectional view of the heating cooker provided with the water treatment device according to the present exemplary embodiment.

In FIG. 12, there is a space formed by partitioning heating chamber 52 using partition wall 61 on a rear of heating chamber 52. Circulation fan 75 that stirs and circulates air in heating chamber 52 is provided in the space. Convection heater 76 serving as an in-room evaporation heater for heating the air circulating in heating chamber 52 is provided so as to surround circulation fan 75.

A plurality of intake vent holes 77 are formed near a center of partition wall 61 for the purpose of blowing the air in heating chamber 52 toward a side of circulation fan 75. A plurality of blowing vent holes 78 are formed in a peripheral edge of partition wall 61, so that air in the space partitioned by partition wall 61 is heated by convection heater 76 and heated air is blown toward a side of heating chamber 52 through the plurality of blowing vent holes 78.

Magnetron 80, which is a microwave generation device, is provided outside heating chamber 52 and on the rear of heating chamber 52 so as to face vertically upward, and is connected to waveguide 81 that transmits microwaves to heating chamber 52. Waveguide 81 has an internal passage formed by bending and welding two aluminum-plated steel plates.

Rotating antenna 82 is provided near the center of heating chamber 52 in a horizontal direction. Rotating antenna 82 is formed of an aluminum-plated steel plate and is connected to motor 83, thus stirring microwaves and irradiating microwaves on heating chamber 52.

While magnetron 80, waveguide 81, rotating antenna 82, and motor 83 are provided in an upper portion of heating chamber 52, these components may be provided on a side of a lower surface or a side surface. Any direction may be set as installation direction.

Microwaves may be supplied to heating chamber 52 only from an opening at an exit of waveguide 81 without providing rotating antenna 82. Additionally, to improve a heating distribution, a turntable that rotates with a food being disposed thereon may be provided on the bottom part of heating chamber 52.

Cooling fan 79 is provided below magnetron 80. Cooling fan 79 takes in cooling air from cooling air inlet ports 55 and cools inside of heating cooker 51.

Controller 84 is provided above cooling fan 79. When a user selects a cooking menu, controller 84 controls magnetron 80, motor 83, circulation fan 75, cooling fan 79, heaters, thermistors, infrared sensor 65, water supply pump 9, operation display unit 57, electric conductivity measurement device 69, an in-chamber lamp (not shown), and the like.

In electric conductivity measurement device 69 at the bottom of heating cooker 51, electric conductivity measurement chamber 87 is constituted by box-shaped rib 85 projecting upward from a bottom part of tank case 3 and electric conductivity measurement chamber cover 86. Electric conductivity measurement chamber cover 86 and rib 85 are sealed by packing (not shown) so that water does not leak out. Two electrodes 88a, 88b made of a stainless steel plate are integrally molded with electric conductivity measurement chamber cover 86. Electrodes 88a, 88b are electrically connected to controller 84 by lead wires.

Water is filled with electric conductivity measurement chamber 87, and then electric conductivity measurement device 69 applies an AC voltage between electrodes 88a, 88b to measure electrical resistance and calculate electric conductivity. When water is almost pure water and no ions are present in the water, the electric conductivity is low. On the other hand, when many ions are present in the water, the electric conductivity is high. The AC voltage is applied to electrodes 88a, 88b, because if a DC voltage is applied, air bubbles are generated on surfaces of electrodes 88a, 88b by electrolysis and thus the electrical resistance cannot be measured correctly.

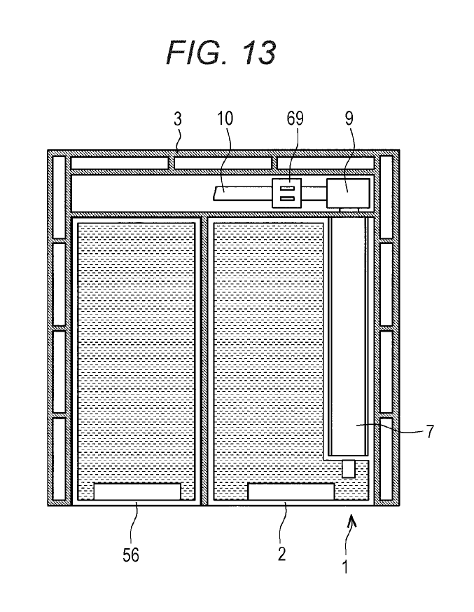

FIG. 13 is a top view of a tank case, a water supply tank from which a lid is removed, and a drain water tank in the heating cooker provided with the water treatment device according to the present exemplary embodiment.

In FIG. 13, water treatment device 1 is constituted by water supply tank 2, water treatment container 7, and water supply pump 9. Water treatment container 7 is accommodated on a right side of water supply tank 2 and outside of water supply tank 2 and is connected to water supply pump 9. Water treatment container 7 may be accommodated in the center of water supply tank 2 or on the left side of water supply tank 2.

The operation and effect of the heating cooker having the above-mentioned configuration are hereinafter described.

### (Steam Heating Operation)

An operation in steam heating is described first.

A user of heating cooker 51 first pulls out water supply tank 2 from tank case 3, pours water in water storage chamber 6 of water supply tank 2 from a water filler (not shown), and inserts water supply tank 2 fully into tank case 3. The user also inserts drain water tank 56 fully into tank case 3.

Next, the user opens door 53, disposes food 100 in heating chamber 52, closes door 53, selects a steam heating operation menu through operation display unit 57, and starts heating.

When heating starts, steam generating device 66 generates heat and thus a temperature of steam generating device 66 increases sufficiently. As shown in FIG. 7A, water supply pump 9 then causes the water in water storage chamber 6 to flow through water supply pipe 23, valve shaft hole 21a, water treatment container inlet port 16, which is an inlet port, diffusion space 15a, mesh member 14a, water treatment material 13, mesh member 14b, diffusion space 15b, valve shaft hole 21b formed in water supply pump connection-part 12, which is an outlet port, and water supply pump inlet port 24.

As shown in FIG. 7B, as the water treatment is continuously performed, dust component 31 such as fine sand or the like having passed through mesh member 14a is accumulated in water treatment material 13 near mesh member 14a. When switch 5 is turned ON under such a state, water supply pump 9 causes the water in water storage chamber 6 to flow through water supply pipe 23, valve shaft hole 21a, water treatment container inlet port 16, which is an inlet port, and diffusion space 15a. Thereafter, water treatment material 13 near mesh member 14a has a large pressure loss because of dust component 31. The water thus avoids dust component 31 and passes through space 30 on the upper surface of water treatment material 13. When the water reaches the upper surface of water treatment material 13 where dust component 31 is not accumulated, the water flows downward in water treatment material 13 by gravity. Thereafter, as in the case before dust component 31 is accumulated, the water flows through mesh member 14b, diffusion space 15b, valve shaft hole 21b formed in water supply pump connection-part 12, which is an outlet port, and water supply pump inlet port 24.

As described above, space 30 on the upper surface of water treatment material 13 is used for enabling water to flow while avoiding dust component 31 when dust component 31 is accumulated in water treatment material 13. It is thus sufficient that height dimension A of space 30 is approximately 1 mm. Effects can be achieved even if height dimension A of space 30 is not equal over the entire area in the length. This is because water treatment material 13 is particulate and the height dimension of water treatment material 13 is equalized by itself by gravity.

While the water passes through water treatment material 13, cations such as calcium ions in the water are converted into hydrogen ions and anions such as silica ions are converted into hydroxide ions. Scale components of the cations and the anions are adsorbed by water treatment material 13, so that the scale components in the water can be removed.

The sucked water is supplied via electric conductivity measurement device 69 and water supply passage 10 to steam generating device 66, which instantaneously generates steam. Since the scale components of the supplied water are removed, it is possible to prevent the scale components from being deposited and adhered to steam generating device 66. Steam may be gradually generated by storing water in steam generating device 66 and heating the water.

Generated steam passes through steam introduction passage 67 to be ejected from steam ejection port 68. Steam ejected from steam ejection port 68 reaches proximity of food 100, condenses into droplets around food 100, applies evaporation latent heat to food 100, thus heating food 100. In particular, when food 100 has many spaces (for example, noodles) or is porous, steam enters food 100 and thus food 100 can be efficiently heated from inside.

When it is detected that the temperature of steam generating device 66 is increased, cooling fan 79 is operated to take in cooling air from cooling air inlet ports 55 and to cool controller 84 and magnetron 80 while preventing an increase in a temperature of steam generating device 66 and near steam generating device 66.

Drain valve 71 is operated almost simultaneously with when heating ends to open drain passage 70 and drain the water in steam generating device 66. After a while, drain valve 71 is operated again to close drain passage 70.

It is needless to mention that when heating is performed continuously, drain passage 70 may be kept closed for a while and thus hot water is stored in steam generating device 66 to quickly generate steam. Alternatively, only when an instruction for water drainage is made by the user, drain passage 70 may be opened. Even if the user forgets to drain water stored in drain water tank 56, the water is automatically drained and thus it is possible to prevent the water from overflowing drain water tank 56.

After heating ends, the user of heating cooker 51 opens door 53 and takes food 100 out of heating cooker 51.

While performance of water treatment material 13 is kept, water treatment material 13 can remove scale components of water as described above, and thus the electric conductivity is low. However, as water treatment continues to be performed, a function of water treatment material 13 to remove the scale components of the water is degraded, and thus the electric conductivity is gradually increased. For example, when electric conductivity measurement device 69 determines that the electric conductivity is equal to or larger than 10 mS/m, it is informed to operation display unit 57 that water treatment material 13 has reached a lifetime and thus water treatment container 7 needs to be replaced. While a value for determining the lifetime is 10 mS/m in the present exemplary embodiment, the value is not limited to 10 mS/m depending on water to be supplied. Moreover, replacement may be informed to a user by turning on a lamp or by sound.

When water treatment container 7 is replaced, water supply tank 2 is first taken out of tank case 3. At this time, water treatment container 7 that is connected to the outside of water supply tank 2 is also taken out with water supply tank 2. Water treatment container 7 is not immersed in water storage chamber 6 in water supply tank 2 and further valves 22a, 22b are closed. Consequently, when water treatment container 7 and water supply tank 2 are taken out, water hardly drips from water treatment container 7 and water supply tank 2 and thus water treatment container 7 can be easily replaced.

### (Microwave Heating Operation)

Next, an operation in microwave heating is described.

A user of heating cooker 51 opens door 53, disposes food 100 in heating chamber 52, closes door 53, selects a microwave heating operation menu through operation display unit 57, and starts heating. Microwaves are then output from magnetron 80. The microwaves propagate in waveguide 81 to be supplied to rotating antenna 82 rotated by motor 83. The microwaves are stirred and irradiated in heating chamber 52 through rotating antenna 82.

Most microwaves are directly absorbed by food 100 to generate heat. Rotation control of rotating antenna 82 enables a distribution of microwaves in heating chamber 52 to be changed. It is possible to select appropriate distribution performance depending on a type, a shape, a position, and a number of foods 100.

While magnetron 80 is operated, cooling fan 79 is operated to take in cooling air from cooling air inlet ports 55 and to cool controller 84 and magnetron 80.

### (Oven Heating Operation)

Next, an operation in oven heating is described.

A user of heating cooker 51 opens door 53, disposes food 100 on a tray (not shown) in heating chamber 52, closes door 53, selects an oven heating operation menu through operation display unit 57, and starts heating. Convection heater 76 generates heat and circulation fan 75 starts to rotate.

As circulation fan 75 is rotated, air in heating chamber 52 is taken from intake vent holes 77 to be heated by convection heater 76. Heated air is then returned to heating chamber 52 again through blowing vent holes 36. In this way, the air in heating chamber 52 is circulated to increase the temperature of heating chamber 52 for the purpose of heating food 100.

During oven heating, cooling fan 79 is operated to take in cooling air from cooling air inlet ports 55 and to cool controller 84 and magnetron 80 while preventing heat from being transferred from heating chamber 52 to water supply tank 2 and drain water tank 56. After the oven operation ends, cooling fan 79 is operated for a while to prevent heat transfer from heating chamber 52.

While the present exemplary embodiment shows heating only by steam, heating only by microwaves, and heating only by an oven, it is possible to perform grill heating by heating chamber heater 59 and composite heating by microwaves and steam. In addition, it is possible to perform heating only by radiant heat or hot air generated by using heating chamber heater 59 and convection heater 76, or to perform composite heating by radiant heat and hot air.

As described above, heating cooker 51 provided with water treatment device 1 is provided in the present exemplary embodiment. When the water treatment is performed and thus dust component 31 such as fine sand in water is accumulated in water treatment material 13 and water treatment material 13 has a large pressure loss, most of the water flows in space 30 defined between the surface of the upper inner wall of water treatment container 7 and water treatment material 13, which functions as a bypass flow passage. The water passes through space 30 on water treatment material 13 in which dust component 31 is gradually accumulated, and then flows downward in water treatment material 13 by gravity. It is thus possible to provide heating cooker 51 provided with water treatment device 1 that can prevent an increase in the pressure loss and a reduction in the flow rate without degrading water treatment performance.

In addition, water supply tank 2 and water treatment container 7 are disposed in tank case 3 at the bottom part of heating cooker 51 such that the lengths of water supply tank 2 and water treatment container 7 are substantially horizontal. Consequently, tank case 3 only needs to be formed in a flat shape. As a result, it is possible to keep a low overall height of heating cooker 51 and thus to provide compact heating cooker 51.

While heating cooker 51 provided with water treatment device 1 is shown in the present exemplary embodiment, water treatment device 1 may be provided in other devices.

As described above, the present invention includes a water treatment container in which a water treatment material for treating water passing through at least a part of the water treatment material is sealed, the water treatment container having an inlet port and an outlet port on horizontally opposite ends of the water treatment container, wherein a space defined between a surface of an upper inner wall of the water treatment container and the water treatment material is provided on at least a part of the water treatment container from the inlet port to the outlet port.

According to this configuration, when water treatment is performed and thus a dust component such as fine sand in water is accumulated in the water treatment material and the water treatment material has a large pressure loss, most of the water flows in the space defined between the surface of the upper inner wall of the water treatment container and the water treatment material, which functions as a bypass flow passage. The water passes through the space on the water treatment material in which the dust component is gradually accumulated, and then flows downward in the water treatment material by gravity. It is thus possible to prevent an increase in the pressure loss and a reduction in a flow rate without degrading water treatment performance.

According to the present invention, a partition plate that partitions the space may be provided in at least a part of the space defined between the surface of the upper inner wall of the water treatment container and the water treatment material.

According to this configuration, when the water flows in the space between the surface of the upper inner wall of the water treatment container and the water treatment material, the partition plate can guide the water into the water treatment material. It is thus possible to prevent the water from flowing only in the space without passing through the water treatment material and degrading the water treatment performance.

Additionally, according to the present invention, a length of the water treatment container in which the water treatment material is sealed may be substantially horizontal.

According to this configuration, the water treatment material remains in a lower portion of the water treatment container by gravity. It is thus possible to form the space by itself between the surface of the upper inner wall of the water treatment container and the water treatment material without using other members. In addition, a height of the space can be substantially equalized over an entire area in the length.

Additionally, the present invention may be a heating cooker provided a water treatment device.

According to this configuration, it is possible to provide the heating cooker provided with the water treatment device that can prevent an increase in the pressure loss and a reduction in the flow rate without degrading the water treatment performance.

### INDUSTRIAL APPLICABILITY

As described above, a water treatment device and a heating cooker provided with the water treatment device according to the present invention are applicable to a water purifier, and a microwave oven, an oven microwave oven, a steam convection oven, a steamer, and a dish washer and dryer, which are provided with a steam generating device, and the like.

### REFERENCE MARKS IN THE DRAWINGS

1: water treatment device
2: water supply tank
3: tank case
4: discharge port
5: switch
6: water storage chamber
7: water treatment container
8: water treatment container accommodating part
9: water supply pump
10: water supply passage
11: water treatment container connection-part
12: water supply pump connection-part (outlet port)
13: water treatment material
14a, 14b: mesh member
15a, 15b: diffusion space
16: water treatment container inlet port (inlet port)
17a, 17b: O-ring
18: water treatment container connection-part
19a, 19b: valve spring
20a, 20b: valve shaft
21a, 21b: valve shaft hole
22a, 22b: valve
23: water supply pipe
24: water supply pump inlet port
28, 28a, 28b: recess
29: water supply tank lid
30: space
31: dust component
32: partition plate
51: heating cooker
52: heating chamber
53: door
54: bottom plate
55: cooling air inlet port
56: drain water tank
57: operation display unit
58: top plate
59: heating chamber heater
60: rail
61: partition wall
62: heating chamber exhaust hole
63: in-chamber thermistor
64: detection hole
65: infrared sensor
66: steam generating device
67: steam introduction passage
68: steam ejection port
69: electric conductivity measurement device
70: drain passage
71: drain valve
72: center part partition
73: water supply tank guide
74: drain water tank guide
75: circulation fan
76: convection heater
77: intake vent hole
78: blowing vent hole
79: cooling fan
80: magnetron
81: waveguide
82: rotating antenna
83: motor
84: controller
85: rib
86: electric conductivity measurement chamber cover
87: electric conductivity measurement chamber
88a, 88b: electrode
100: food

1. A water treatment device comprising a water treatment container in which a water treatment material for treating water passing through at least a part of the water treatment material is sealed, the water treatment container having an inlet port and an outlet port on horizontally opposite ends of the water treatment container,
wherein a space defined between a surface of an upper inner wall of the water treatment container and the water treatment material is provided on at least a part of the water treatment container from the inlet port to the outlet port.

2. The water treatment device according to claim 1, wherein a partition plate that partitions the space is provided in at least a part of the space.

3. The water treatment device according to claim 1, wherein a length of the water treatment container is substantially horizontal.

4. The water treatment device according to claim 2, wherein a length of the water treatment container is substantially horizontal.

5. A heating cooker comprising the water treatment device according to claim 1.
